(19) United States
(12) Patent Application Publication
(10) Pub. No.: US 2004/0191735 A1
(43) Pub. Date: Sep. 30, 2004

(54) Method and system for simulating activity in a contact centre

(76) Inventor: Tony McCormack, Galway (IE)

Correspondence Address: William M. Lee, Jr., Barnes & Thornburg, P.O. Box 2786, Chicago, IL, 60690-2786, US

(21) Appl. No.: 10/395,924

(22) Filed: Mar. 24, 2003

(51) Int. Cl. G09B 19/00

(52) U.S. Cl. 434/219

(57) ABSTRACT

A method and system for simulating activity in a contact centre includes an interface for inputting a desired activity profile for the contact centre, a statistical data feed of the actual contact centre activity level, and a comparison unit for comparing actual activity levels with desired levels. Based on this comparison, one or more associated contact generators are instructed to generate additional contacts to the contact centre to bring the actual activity into line with the desired profile. This enables a working contact centre to be brought to a desired level of activity when under the control of a trainee supervisor, providing a more realistic training environment to be achieved.

### FIELD OF THE INVENTION

The present invention relates to methods and systems for simulating activity in contact centres. The invention has particular application in training and assessing supervisors of contact centres.

### BACKGROUND OF THE INVENTION

Contact centres, such as call centres and multimedia call centres, are subject to varying levels of activity to which they must respond using the resources available at any given time. The resources available are not static but vary during the day and from day to day as the number of agents active fluctuates. Even where a relatively stable number of agents is available, the skillsets available to respond to the workload will not remain constant.

Individual agents in a contact centre will have different skillsets i.e. varying levels of ability to handle different incoming and outgoing contacts based on e.g. the media type of the contact (voice call, email, video call, webchat session, etc.), the language of the contact, and the technical requirements of satisfactorily dealing with queries regarding particular products or services.

The primary role of the supervisor is to manage the resources available based on the activity levels and stresses on the contact centre. This can be done by scheduling agent breaks, authorising overtime for agents with skillsets in high demand, and varying the ability rating assigned to individual skillsets for particular agents or the criteria used to assign contacts to agents. In this way, agents with skillsets in high demand can be reserved to deal with a contacts for which their skills are currently in high demand.

It can be difficult to subject supervisors to a realistic training environment, i.e. to create simulations in which they can train and be properly assessed.

### SUMMARY OF THE INVENTION

The invention provides, in a first aspect, a system for simulating activity in a contact centre, said system comprising an interface for programming the system with a desired contact centre activity level, a statistical input for receiving statistical data relating to an activity level of the contact centre, a processor for comparing the statistical data and the desired activity level and in response to this comparison outputting control signals to an associated contact generator to thereby control the generation of simulated contacts to the contact centre.

This system enables the simulation of a desired activity level within a real contact centre environment. Thus, for example, a trainee supervisor can take control of a working contact centre at periods when the real activity of the centre is relatively low, and the system of the invention can simulate a higher activity level by causing the contact generator to generate a sufficient number of contacts to bring the activity of the centre (as perceived by the supervisor) to a much higher level, requiring the supervisor to take corrective action.

One of the primary advantages provided by the invention is that it enables a supervisor to train within the real working environment of a contact centre, managing real agents and thereby requiring the supervisor to exercise not only technical skills (dealing with the technical systems under his or her control) but also management skills (dealing with the agents under his or her control).

While it would be possible to envisage a virtual contact centre environment in which virtual agents receive virtual contacts which could be generated to any desired level, this is not a realistic training environment. For example, at periods of high simulated demand in such a virtual environment, the supervisor might react by specifying that all agents work a shortened meal break. In reality, however, such a solution might not be acceptable to some or all agents. This does not provide a realistic training scenario, since the supervisor must be trained not only in technical management issues but also in people management techniques, and this is not possible with virtual agents. By using the system of the invention, the activity level of a real centre can be artificially varied so that the supervisor is obliged to manage the situation in a realistic manner with proper management skills.

One of the other primary benefits of the system is that it allows training to take place within a contact centre while the normal activity of the contact centre continues. Again, it would be possible to create a training contact centre environment, with a large number of real agents all responding to simulated contacts under the control of the trainee supervisor. Economically, however, it would be unjustifiable to recruit several hundred agents to act their part in such a simulation for the benefit of training one or a few supervisors. The invention enables an existing contact centre to maintain its day-to-day activity, with the system of the invention being used to artificially add stresses (in the form of simulated additional contacts) as part of the real environment.

Because the real working of the contact centre continues, the supervisor is also prevented from considering his or her actions as part of a “mere training exercise”. The supervisor will see the activity levels of the contact centre rise (to meet the desired level of demand programmed into the simulation system) but will be aware that some proportion of the contacts arriving into the centre (perhaps the large majority) will be real contacts which cannot be treated lightly.

The invention takes advantage of feedback from the statistical data generated in real time by the contact centre to vary the number of artificially generated contacts. Thus, if during a training session the number of real incoming contacts rises unexpectedly, this will cause the processor to reduce the number of contacts generated by the contact generator.

Preferably, the statistical data include data relating to activity levels of different skillsets and the desired activity level specifies activity levels for different skillsets, and the processor issues commands to generate different numbers of simulated contacts relating to different skillsets.

In this manner, the contact levels for different media types, or different languages, or different technical issues (to name a few skillset variables) can be varied individually to stress the operation of the contact centre in specific ways. This is advantageous in that it allows the system to be programmed, in the environment of a given contact centre, with activity patterns which are known to be difficult to handle in that contact centre.

For example, if only a few agents in a Spanish contact centre are fluent in German, while a further few agents are competent but not highly proficient in German, the skillsets of the latter group of agents might not normally include German. The contact centre management software typically maintains a skillset profile for each agent, and so the agents in the first group of fluent speakers might be rated with ability levels in German of “1” or “2” and those in the latter group with ability levels of “3”, “4” or “5”. In normal operation of the contact centre, calls, emails, webchat sessions, etc. would be assessed on the basis of language requirements, and might be directed only to agents whose language ability is rated as “1” or “2”. If, however, there is a sudden rush of incoming German contacts, a proficient supervisor might reassign the ability levels of the less proficient speakers to “2” temporarily (or lower the threshold for dealing with German contacts to “4” for example). In this way, the incoming contacts could be efficiently absorbed by the centre, at the expense of having some German contacts dealt with by agents with imperfect language abilities.

Alternatively, the skillsets of the fluent speakers might be temporarily varied to remove their competence to deal with emails and webchat sessions, and such contacts could be assigned to the less fluent speakers, so that the fluent speakers are temporarily dedicated to handling calls, and the emails and webchat sessions are temporarily assigned to those with a lesser competence in German (whose language shortcomings would be less noticeable in a text-based medium).

To allow such a scenario to occur, the numbers of real contacts of a given language type are supplemented by virtual generated contacts of a given language type which are directed to the agents whose skillsets are indicated to be suitable to handle the contacts (based on the criteria set by the supervisor).

Preferably, the system of the invention includes said associated contact generator. Alternatively, the contact generator might be external to the system of the invention but in communication with the processor.

There may be a plurality of contact generators associated with the system of the invention. For example, a call generator might be present to generate incoming calls, and an email generator might also be present to select emails from a store of emails and to transmit selected emails to the contact centre. Other contact generators might include a chat message generator to generate or initiate an electronic chat session; a text message generator to generate text based telephony messages such as short messaging service (SMS) messages; an instant message generator to generate web-based instant messages; a fax generator to generate facsimile messages; a web form generator to generate data simulating a submitted web-based form; and a video call generator to generate a video call.

In preferred embodiments, the desired activity level programmed into the system is in the form of an activity profile which varies with time.

Preferably, the profile specifies different activity levels for different skillsets, with one or more of the skillset activity levels varying over time.

Using activity profiles of this type, it is possible to stress the contact centre in different ways and to assess the ability of a supervisor to react to such stresses and maintain an acceptable mode of operation of the contact centre.

Preferably, the system of the invention also includes an input for receiving indicators of actions taken to vary the operation of the contact centre and a memory for storing a record of said actions.

By recording the actions of the supervisor, it is possible to reverse the effects of the supervisor's actions and to return the contact centre to normal operation if so desired, such as at the end of a training session or if the actions of the supervisor jeopardise the normal operation of the centre.

The invention also provides a method of simulating activity in a contact centre, comprising the steps of receiving an input defining a desired contact centre activity level, receiving statistical data relating to an activity level of the contact centre, comparing the statistical data and the desired activity level and, in response to this comparison, outputting control signals to a contact generator to thereby control the generation of simulated contacts to the contact centre.

In a further aspect the invention provides a computer program for execution by a processor connected to a contact generator, which when executed causes the processor to carry out the steps of: receiving an input defining a desired contact centre activity level, receiving statistical data relating to an activity level of the contact centre, comparing the statistical data and the desired activity level and, in response to this comparison, outputting control signals to a contact generator to thereby control the generation of simulated contacts to a contact centre.

The invention also provides a contact centre comprising a plurality of agent stations connected to a communications network to enable contacts to be made between the network and the agent stations; a contact centre management unit for managing and monitoring the processing of contact by the agent stations; a supervisor interface for enabling a supervisor to vary the operation of the contact centre management unit; and a system for simulating activity in the contact centre, said system comprising an interface for programming the system with a desired contact centre activity level, a statistical input for receiving statistical data relating to an activity level of the contact centre, a processor for comparing the statistical data and the desired activity level and in response to this comparison outputting control signals to an associated contact generator to thereby control the generation of simulated contacts to the contact centre.

In another aspect the invention provides a method of training a contact centre supervisor comprising the steps of: defining a desired activity level for a contact centre under partial or total control of the supervisor; monitoring an actual activity level of said contact centre; generating artificial contacts to the contact centre to bring the actual activity level into line with the desired activity level; and monitoring the response of the supervisor to the resultant change in activity levels.

### BRIEF DESCRIPTION OF DRAWINGS

The invention will now be illustrated by the following descriptions of embodiments thereof given by way of example only with reference to the accompanying drawings, in which:

FIG. 1 is an architecture showing the system of the invention within a contact centre environment;

FIG. 2 is a flowchart of a process used in implementing the method of the invention; and

FIG. 3 is a decision table used in the process of FIG. 2

### DETAILED DESCRIPTION OF PREFERRED EMBODIMENTS

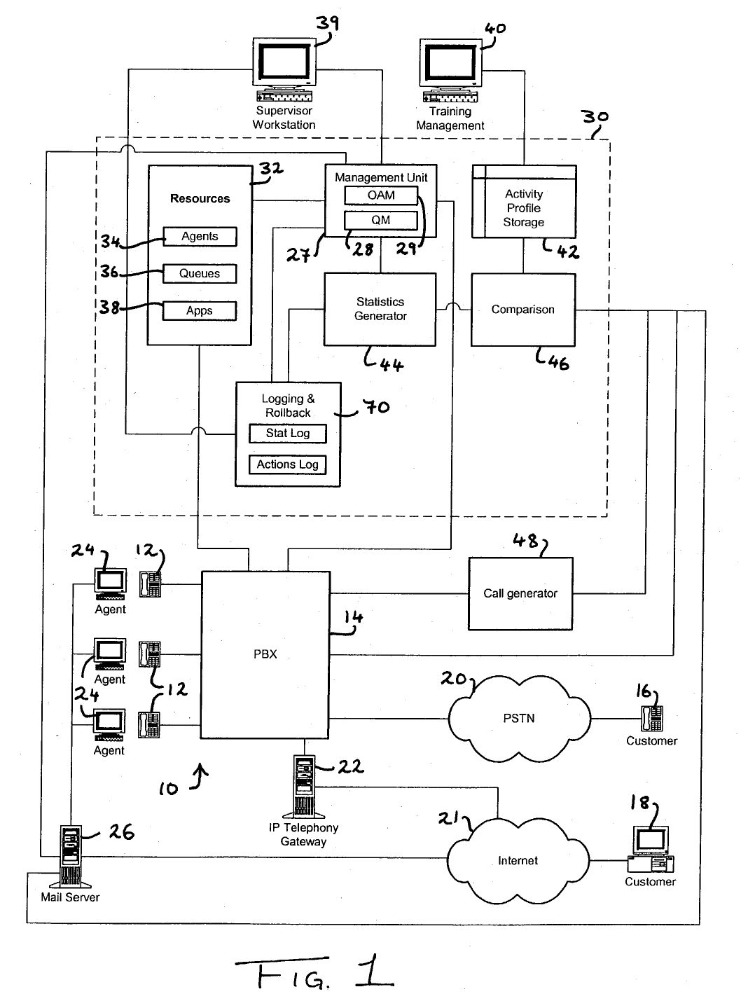

FIG. 1 shows a system for simulating contacts in a contact centre, incorporated within a contact centre environment. As in a conventional contact centre a number of agent stations 10, are provided to enable agents to deal with contacts of different media types including voice calls and emails. Each agent receives and makes voice calls using a telephone handset 12 connected to a private branch exchange (PBX) 14. The PBX 14 receives calls from customers 16,18 from the public switched telephone network 20 or from the Internet 21 via an Internet protocol telephony gateway 22. Emails are received at agent workstations 24 from an email server 26 connected to the Internet 21. Outgoing calls and emails can also be sent via the same paths.

When contacts such as calls and emails are received by the PBX or the email server, distribution of these contacts is controlled by a management unit 27 in a call centre management system 30. The management unit 27 comprises a queue manager (QM) 28 and an operations administration & management (OAM) unit 29. The QM 28 allocates calls to appropriate agents based on records of current resources 32 including lists of agents currently available 34 (and the skillsets for which each agent is qualified), the queues of contacts of various types 36, and lists 38 of the applications which are available for each agent.

Incoming contacts are classified by skillset (based on for example the media type of the contact, the language of the contact, and the subject of the contact, which can be automatically determined in known manner by e.g. text analysis, interactive voice response systems, and options chosen on a web page when the contact is initiated). Based on these skillsets, a token for each contact is placed in an appropriate queue, and the contact held at the email server 26 or held at the PBX 14 until the QM unit 28 determines that an agent is available to deal with the contact, at which point it instructs the PBX to transfer the call or the server to forward the email, as appropriate to the identified agent.

The OAM interface 29 is connected to a supervisor workstation interface 39 which enables a contact centre supervisor to vary skillset assignments, or vary the criteria by which contacts are assigned to agents, or to vary other parameters of the contact centre in order to better manage the queued contacts.

The operation of the contact centre as thus far described is conventional. The system illustrated in FIG. 1 however enables the activity levels of the contact centre to be varied, in particular to enable a training environment to be simulated.

The system includes a training management workstation 40 which enables an activity profile to be stored in an activity profile store 42. An example of such an activity profile is shown below for an hour-long training session for a contact centre in which incoming contacts are classified into four skillsets A-D.

Skillsets A, B and C might define incoming calls in German, Japanese and English, respectively, and skillset D might be all incoming emails. (In practice, far more skillsets are likely to exists, classifying contacts in terms of other media types and in terms of the subject-matter of the contacts; the simplified set of four skillsets is given for illustration purposes only.)

| | Time (mins): | | | |
|---|---|---|---|---|
| | 0 to 25 | 26 to 34 | 35 to 51 | 52 to 60 |
| Skillset A (calls/min) | 8 | 10 | 9 | 7 |
| Skillset B (calls/min) | 0 | 0 | 2 | 8 |
| Skillset C (calls/min) | 43 | 38 | 50 | 40 |
| Skillset D (calls/min) | 1 | 4 | 0 | 1 |

It can be seen that the number of calls to be received in Japanese (skillset B) increases significantly in the final period, and this would require action on the part of a supervisor where the number of fluent Japanese agents is low (such as by dedicating these agents to receive only calls in this skillset, or temporarily upgrading the less fluent agents to allow them to handle calls. It may also require reassigning some agents who had been assigned to handle the increased number of emails received in the second period away from that duty back to voice calls. This may therefore provide a useful test of a trainee supervisor's skills, though in practice more sophisticated profiles would be used.

Because the contact centre in its normal operation will receive external contacts (over which the contact centre itself has, by and large, little control), the invention is concerned with bringing the contact centre to the desired activity level while maintaining the flow of genuine incoming contacts. A statistics generator 44 connected to the QM 28 provides a feed of statistical data defining the actual activity levels of the centre. For the purposes of this explanation, the statistical data will include the number of contacts received within each skillset per minute.

A comparison unit 46 compares the actual activity levels of the contact centre and the specified activity level stored in the profile storage unit and then takes appropriate action by instructing a call generator 48 to generate more incoming calls, or email server 26 to simulate an increased number of incoming emails. This process will now be described more fully.

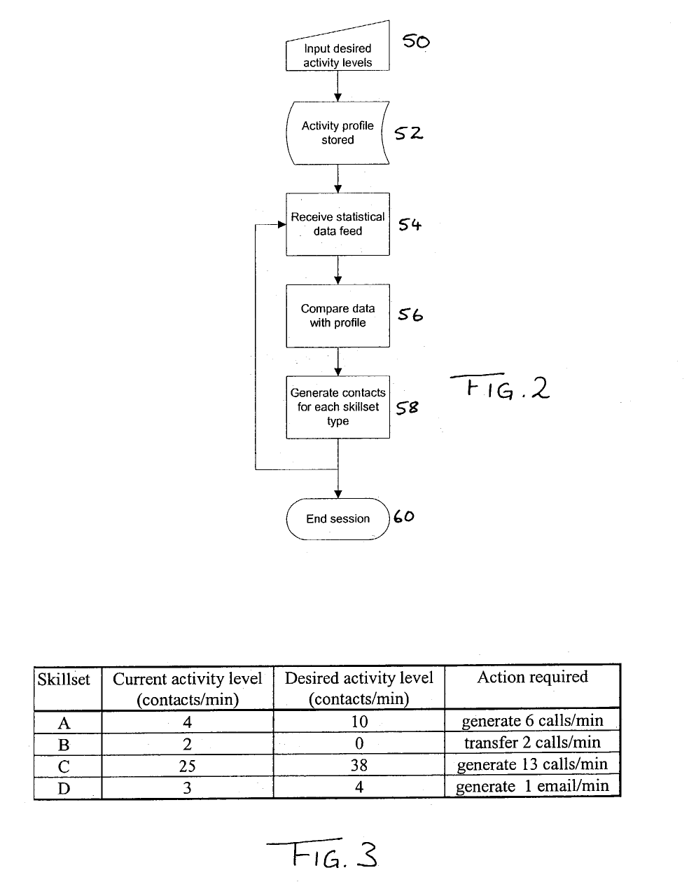

FIG. 2 shows the process flow carried out in generating the required contacts to bring the activity levels of the contact centre into line with the profile. In steps 50 and 52 the activity profile is input and stored, respectively. When the training session begins, the statistical data feed is received by the comparison unit 46, step 54. This data is compared with the stored profile, step 56, and a decision is taken by the comparison unit to generate additional contacts or take other appropriate action to bring the activity levels into line with the profile, step 58. This series of steps 54,56,58 repeats until the training session ends, step 60.

FIG. 3 shows how the comparison and decision making in steps 56 and 58 might be achieved by a suitably programmed processor. The number of contacts received in each skillset is compared to the number of contacts desired for that skillset. The difference between these figures leads to a number of contacts to be generated, or if there are too many real contacts being received, the option may exist (as for skillset B) to transfer these contacts to another contact centre in a network of contact centres (otherwise, this condition might alert a training manager at training workstation 40 that the desired activity profile has been exceeded, allowing the training manager to vary the profile for other skillsets, or perhaps simply to monitor the response of the trainee supervisor).

The decision table of FIG. 3 is updated to reflect the changing statistical data over time. It will be appreciated that whereas both this decision table and the activity profile are defined in terms of contacts received per minute, one can also define these entities in terms of the total number of active contacts at the contact centre at a given time.

Where calls are to be generated according to the decision table of FIG. 3, the comparison processor 46 will instruct the call generator 48 to generate calls of a specific nature to the PBX. Such calls may include data indicating the skillset and a fixed call duration to the PBX. The PBX recognises the skillset and holds the call, informing the contact centre management system of the existence of the call and the skillset in question. A token for the call is inserted in the relevant queue, and when the call is assigned to an agent, the PBX may play a pre-recorded message to inform the agent that this is a training call which should be maintained until it is terminated. After a predetermined period of time, the call generator or the PBX terminates the call, releasing the agent.

Where emails are to be generated, the email server is informed of this requirement. A training application within the email server is connected to a store of appropriate emails, and one of these emails is selected from the store and placed in the active queue. The content of the stored emails may be of a type which a competent agent can deal with in a set period of time, or it may simply instruct the agent to take no other action for a defined period of time.

In the case of both the generated emails and the generated calls, the effect is to have an agent assigned to a virtual contact of a given skillset for a predetermined period of time (or perhaps a random period selected from a particular range). The trainee supervisor must manage the contact centre resources to deal with the apparent increase in activity levels resulting from the artificially generated contacts.

The comparison unit is also connected to the PBX to allow instructions to be given to agents directly to make an outgoing call of a particular duration (to mimic the fact that agents can be tied up by a schedule of outgoing calls to be made as well as by incoming calls).

A logging and rollback unit 70 (FIG. 1) is provided to monitor and log all of the statistical data as well as the actions taken by the trainee supervisor at the OAM unit 29. This enables the actions of the trainee to be analysed after the training session for appraisal purposes, and enables any actions taken (such as agent reassignment, redefinition of criteria for assigning contacts, etc.) to be reversed very quickly by the training manager at the end of the session or during the session should this be necessary.

It will be appreciated that the system of the invention allows a trainee supervisor to be immersed in the environment of a real working contact centre having any specified level of activity, which provides a test of both the technical skills and the management skills possessed by that trainee.

As a variation on the embodiment thus far described, the simulated contacts can be handled within the contact centre separately from the regular (genuine) incoming contacts. This may be done by nominating a set of agents to deal with the simulated contacts (e.g. by adding this as a skillset parameter and creating rules to distribute only simulated contacts to those agents with the relevant parameter in their skillsets). The remaining agents handle the genuine workload of the contact centre during the training session and the nominated set of agents operate in a virtual environment.

The invention is not limited to the embodiments described herein which may be varied or departed from within the scope and spirit of the invention.

What is claimed is:

1. A system for simulating activity in a contact centre, said system comprising:
an interface for programming the system with a desired contact centre activity level,
a statistical input for receiving statistical data relating to an activity level of the contact centre, and
a processor for comparing the statistical data and the desired activity level and in response to this comparison outputting control signals to an associated contact generator to thereby control the generation of simulated contacts to the contact centre.

2. A system as claimed in claim 1, wherein the statistical data include data relating to activity levels of different skillsets and the desired activity level specifies activity levels for different skillsets, and the processor issues commands to generate different numbers of simulated contacts relating to different skillsets.

3. A system as claimed in claim 1, further comprising said associated contact generator.

4. A system as claimed in claim 1, wherein the contact generator is external to the system but in communication with the processor.

5. A system as claimed in claim 1, wherein a plurality of contact generators is associated with the system.

6. A system as claimed in claim 1, wherein said contact generator is selected from a call generator to generate incoming calls; an email generator to select emails from a store of emails and to transmit selected emails to the contact centre; a chat message generator to generate or initiate an electronic chat session; a text message generator to generate text based telephony messages such as short messaging service (SMS) messages; an instant message generator to generate web-based instant messages; a fax generator to generate facsimile messages; a web form generator to generate data simulating a submitted web-based form; and a video call generator to generate a video call.

7. A system as claimed in claim 1, wherein the desired activity level programmed into the system is in the form of an activity profile which varies with time.

8. A system as claimed in claim 7, wherein the profile specifies different activity levels for different skillsets, with one or more of the skillset activity levels varying over time.

9. A system as claimed in claim 1, further comprising an input for receiving indicators of actions taken to vary the operation of the contact centre and a memory for storing a record of said actions.

10. A method of simulating activity in a contact centre, comprising the steps of:
receiving an input defining a desired contact centre activity level, receiving statistical data relating to an activity level of the contact centre,
comparing the statistical data and the desired activity level and,
in response to said comparison, outputting control signals to a contact generator to thereby control the generation of simulated contacts to the contact centre.

11. A method as claimed in claim 10, wherein said statistical data relates to an activity level of a subset of agents at the contact centre, whereby when said simulated contacts are received they mat be distributed exclusively to said subset of agents.

12. A computer program product in machine readable form for execution by a processor connected to a contact generator, which when executed causes the processor to:
receive an input defining a desired contact centre activity level,
receive statistical data relating to an activity level of the contact centre,
compare the statistical data and the desired activity level and,
in response to said comparison, output control signals to a contact generator to thereby control the generation of simulated contacts to a contact centre.

13. A contact centre comprising:
a plurality of agent stations connected to a communications network to enable contacts to be made between the network and the agent stations;
a contact centre management unit for managing and monitoring the processing of contact by the agent stations;
a supervisor interface for enabling a supervisor to vary the operation of the contact centre management unit; and
a system for simulating activity in the contact centre, said system comprising:
an interface for programming the system with a desired contact centre activity level,
a statistical input for receiving statistical data relating to an activity level of the contact centre, and
a processor for comparing the statistical data and the desired activity level and in response to this comparison outputting control signals to an associated contact generator to thereby control the generation of simulated contacts to the contact centre.

14. A method of training a contact centre supervisor comprising the steps of:
defining a desired activity level for a contact centre under partial or total control of the supervisor;
monitoring an actual activity level of said contact centre;
generating artificial contacts to the contact centre to bring the actual activity level into line with the desired activity level; and
monitoring the response of the supervisor to the resultant change in activity levels.
